(19) United States
(12) Patent Application Publication
(10) Pub. No.: US 2013/0140135 A1
(43) Pub. Date: Jun. 6, 2013

(54) BELT CONVEYOR FOR CONVEYING SOLAR WAFERS DURING FABRICATION

(71) Applicants: Lian Hok Tan, Singapore (SG); Wen Ge Tu, Singapore (SG)

(72) Inventors: Lian Hok Tan, Singapore (SG); Wen Ge Tu, Singapore (SG)

(21) Appl. No.: 13/309,699

(22) Filed: Dec. 2, 2011

(51) Int. Cl. B65G 21/20; B65G 45/18; B65G 49/00

(52) U.S. Cl. 198/345.1; 198/339.1

(57) ABSTRACT

Disclosed is a belt conveyor, which conveys solar wafers during fabrication, comprising: i) a plurality of endless metal strips for supporting the solar wafers; ii) a plurality of rotatable pulleys configured to receive the plurality of endless metal strips, and which rotate to convey each of the plurality of endless metal strips along a continuous path to thereby convey the solar wafers; and iii) an inspection device configured to inspect the solar wafers while the solar wafers are being conveyed by the plurality of endless metal strips.

### FIELD OF THE INVENTION

The present invention relates to a belt conveyor for conveying solar wafers as they move across different process stations during fabrication.

### BACKGROUND OF THE INVENTION

Solar cells are electrical devices that convert light energy into electrical energy based on the photovoltaic (‘PV’) effect. By stringing solar cells together, a PV solar panel can be formed to provide a power generating device. Additionally, solar cells have been used as a backup power supply for various consumer products such as mobile phones and personal digital assistants.

Fabrication of solar cells involves three-dimensional (‘3D’) inspection such as inspection of wafer uniformity, hot spots, array non-uniformity, and surface contamination levels. Solar wafers are the raw material used to fabricate solar cells. Typically, the solar wafers are conveyed by a belt conveyor along a conveying path through a detection area, where the 3D inspection is performed on-the-fly by laser and vision systems to provide various measurements of the solar wafers such as the thickness dimension, bow and warp. Unfortunately, conventional belt conveyors for conveying solar wafers are prone to vibratory motion during operation. Thus, solar wafers that are conveyed by conventional belt conveyors often experience an offset displacement (e.g. Z-axis variation) from the conveying path as the solar wafers are conveyed through the detection area. Such an offset displacement as caused by the vibratory motion of conventional belt conveyors affects the on-the-fly inspection accuracy of solar wafers during fabrication.

One method of addressing the offset displacement problem among conventional belt conveyors is by confining the inspection regions of solar wafers to spots (or lines). However, such a method merely serves to minimize the impact of the offset displacement problem on the on-the-fly inspection accuracy but does not address the vibratory motion of conventional belt conveyors that causes the problem. Moreover, the on-the-fly inspection accuracy is not significantly improved through this method of inspecting solar wafers.

Thus, it is an object of this invention to seek to address the vibratory motion of conventional belt conveyors for conveying solar wafers during fabrication, in order to improve the on-the-fly inspection accuracy of solar wafers during fabrication.

### SUMMARY OF THE INVENTION

An aspect of the present invention is a belt conveyor for conveying solar wafers during fabrication, the belt conveyor comprising: i) a plurality of endless metal strips for supporting the solar wafers; ii) a plurality of rotatable pulleys configured to receive the plurality of endless metal strips, and which rotate to convey each of the plurality of endless metal strips along a continuous path to thereby convey the solar wafers; and iii) an inspection device configured to inspect the solar wafers while the solar wafers are being conveyed by the plurality of endless metal strips.

By using the plurality of endless metal strips to support the solar wafers, the belt conveyor is able to minimize its vibratory motion when conveying the solar wafers during fabrication. Consequently, any offset displacement as experienced by each the plurality of endless metal strips relative to its corresponding continuous path is also minimized, and thus, the accuracy of the on-the-fly inspection of the solar wafers by the inspection device is advantageously enhanced.

Some optional features of the belt conveyor have been defined in the dependent claims.

For instance, the belt conveyor may further comprise a chassis, wherein the plurality of rotatable pulleys are arranged at opposite ends of the chassis. The plurality of endless metal strips may be arranged along opposed edges of the chassis. Accordingly, the plurality of endless metal strips may be used for supporting opposite edges of the solar wafers to advantageously provide additional stability of the solar wafers as they are conveyed by the belt conveyor during fabrication.

Preferably, the chassis may comprise at least one cavity so that the inspection device is operative to inspect the solar wafers through the at least one cavity while the solar wafers are being conveyed by the plurality of endless metal strips.

Further, each of the plurality of rotatable pulleys may comprise a protruding curved surface over which a width of the corresponding endless metal strip is received. Such curved surfaces of the plurality of rotatable pulleys may have the advantage of providing a stronger grip on the plurality of endless metal strips to ensure that they are not detached from the plurality of rotatable pulleys.

In addition, the belt conveyor may comprise a device operative to generate an attraction force on the plurality of endless metal strips towards the chassis to minimize an offset displacement of the plurality of endless metal strips with respect to the continuous path. Since the offset displacement as experienced by each of the plurality of endless metal strips relative to its corresponding continuous path is further minimized, the on-the-fly inspection accuracy of the solar wafers may advantageously be further improved.

In some embodiments, the device to generate an attraction force may comprise a vacuum pump. The chassis may comprise a plurality of open-ended interior channels, wherein one end of the plurality of open-ended interior channels contacts the plurality of endless metal strips whereas the opposite end of the plurality of open-end interior channels is connected to the vacuum pump. In this way, a negative pressure is created within the interior channels—when the vacuum pump is operative—to generate a force on the plurality of endless metal strips towards the chassis. In other embodiments, the device to generate an attraction force may comprise a magnet to generate a magnetic force on the plurality of endless metal strips towards the chassis.

Furthermore, the belt conveyor may comprise a cleaning device for cleaning the plurality of endless metal strips. The cleaning device may either comprise a brush having bristles for brushing, or a wiper for wiping, the plurality of endless metal strips. By providing the cleaning device, the belt conveyor may remove contaminants such as silicon dust and/or solar particles that may be accumulated on the plurality of endless metal strips to prevent such contaminants from contaminating the solar wafers during fabrication. Advantageously, the quality of the fabricated solar wafers may be improved.

### BRIEF DESCRIPTION OF THE DRAWINGS

Embodiments of the drawings will now be described, by way of example only, with reference to the accompanying drawings of which:

FIG. 1 is a perspective view of a belt conveyor according to an embodiment of the invention;

FIG. 2a and FIG. 2b show different cross-sections of the belt conveyor of FIG. 1 along lines A-A′ and B-B′ respectively as shown in FIG. 1;

FIG. 3 is a perspective view of a belt conveyor according to another embodiment of the invention, which comprises a brush and a wiper; and

FIG. 4a and FIG. 4b show the brush and the wiper of the belt conveyor of FIG. 3 respectively.

### DETAILED DESCRIPTION OF THE PREFERRED EMBODIMENTS

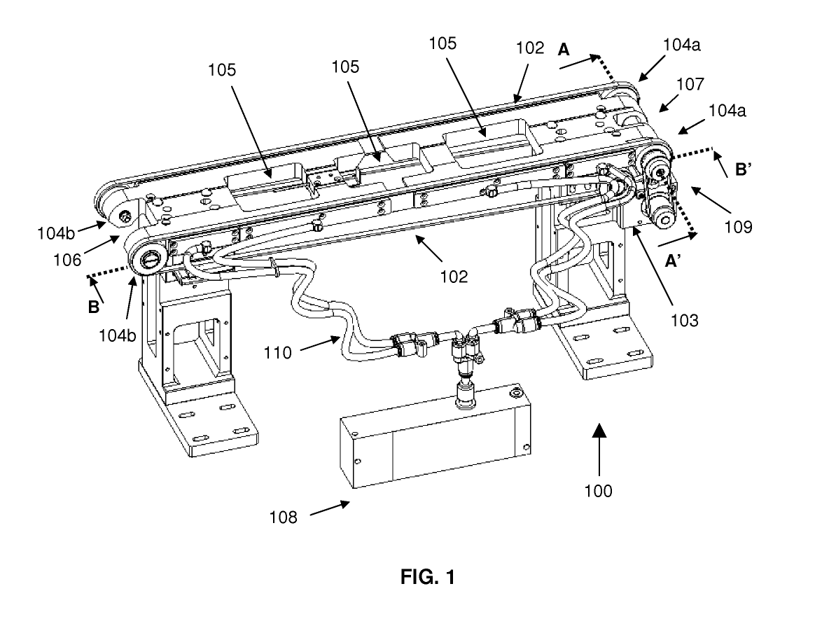

FIG. 1 is a perspective view of a belt conveyor 100 for conveying solar wafers during fabrication, according to a first embodiment of the invention. The belt conveyor 100 comprises: i) a plurality of endless metal strips 102 of uniform width; and ii) a plurality of rotatable pulleys 104a, 104b configured to receive the plurality of endless metal strips 102, which rotate to convey each of the plurality of endless metal strips 102 along a continuous path to thereby convey the solar wafers. The size of a solar wafer typically ranges from about 100 mm by 100 mm to about 210 mm by 210 mm.

A high resolution encoder servo motor 103 is used to drive the plurality of rotatable pulleys 104a, 104b so that motion of the plurality of rotatable pulleys 104a, 104b is synchronized. Specifically, the rotatable pulleys 104a are fixedly connected to an axle 107, and additionally, a timing belt 109 is arranged between the servo motor 103 and the axle 107. Thus, the rotatable pulleys 104 rotate together with the axle 107 when the latter is driven by the servo motor 103. Since the rotatable pulleys 104a are connected to the rotatable pulleys 104b via the respective endless metal strips 102, rotation of the rotatable pulleys 104a accordingly drive the other rotatable pulleys 104b to rotate. It should therefore be appreciated that the arrangement of the rotatable pulleys 104a, 104b, the axle 107, the servo motor 103, and the timing belt 109 allows the endless metal strips 102 to be conveyed synchronously along their respective continuous paths to thereby convey the solar wafers during fabrication.

FIG. 1 also shows that the rotatable pulleys 104a, 104b are arranged at opposite ends of a chassis 106 of the belt conveyor 100 so that the endless metal strips 102 can be tensioned over the respective rotatable pulleys 104a, 104b and the chassis 106. As such, the endless metal strips 102 are preferably made of high-tension seamless stainless steel strips. In addition, the thickness of each of the endless metal strips 102 may be between 0.3 mm and 0.6 mm, while the width may be between 5 mm and 10 mm respectively. Specifically, the thickness tolerance of the plurality of endless metal strips 102 is controlled to within +/−5 microns relative to a predetermined dimension (e.g. 0.5 mm).

Moreover, the endless metal strips 102 are arranged along respective opposed edges of the chassis 106. Such an arrangement allows the endless metal strips 102 to support each of the solar wafers along its opposite edges to provide stability as the solar wafer is conveyed by the belt conveyor during fabrication. It should be appreciated that the distance between the endless metal strips 102 depends on the size of the solar wafers that are conveyed by the belt conveyor 100. For instance, the distance between the endless metal strips 102 may range from about 10 mm to 150 mm.

Though not shown in FIG. 1, the belt conveyor 100 also comprises an inspection device for inspecting the solar wafers. For instance, the inspection device may include a 3D inspection system—comprising laser and vision systems—for measuring various dimensions (e.g. thickness) of the solar wafers. Specifically, the chassis 106 includes cavities 105 so that the 3D inspection system can be arranged above and below the belt conveyor 100 to measure the various dimensions of the solar wafers as the solar wafers are conveyed by the belt conveyor 100 during fabrication.

By providing the endless metal strips 102 for supporting the solar wafers, the belt conveyor 100 is able to minimize vibratory motion as the solar wafers are being conveyed by the belt conveyor 100 during fabrication. For instance, oscillations of the vibratory motion of each of the endless metal strips 102 (and hence of the solar wafers conveyed) may be limited to +/−10 microns relative to the respective continuous path. Such an accuracy level allows many 3D defects to be detected by the inspection device when determining, for example, the thickness variation of the solar wafers, the sawmark depth of the solar wafers, presence of splinters, bow and/or warp of the solar wafers.

It should therefore be appreciated that through the use of the belt conveyor 100 to convey the solar wafers during fabrication, the reduction of the offset displacement as experienced by the endless metal strips 102 relative to their respective continuous paths advantageously improves the on-the-fly inspection accuracy of the solar wafers as they are conveyed by the belt conveyer 100.

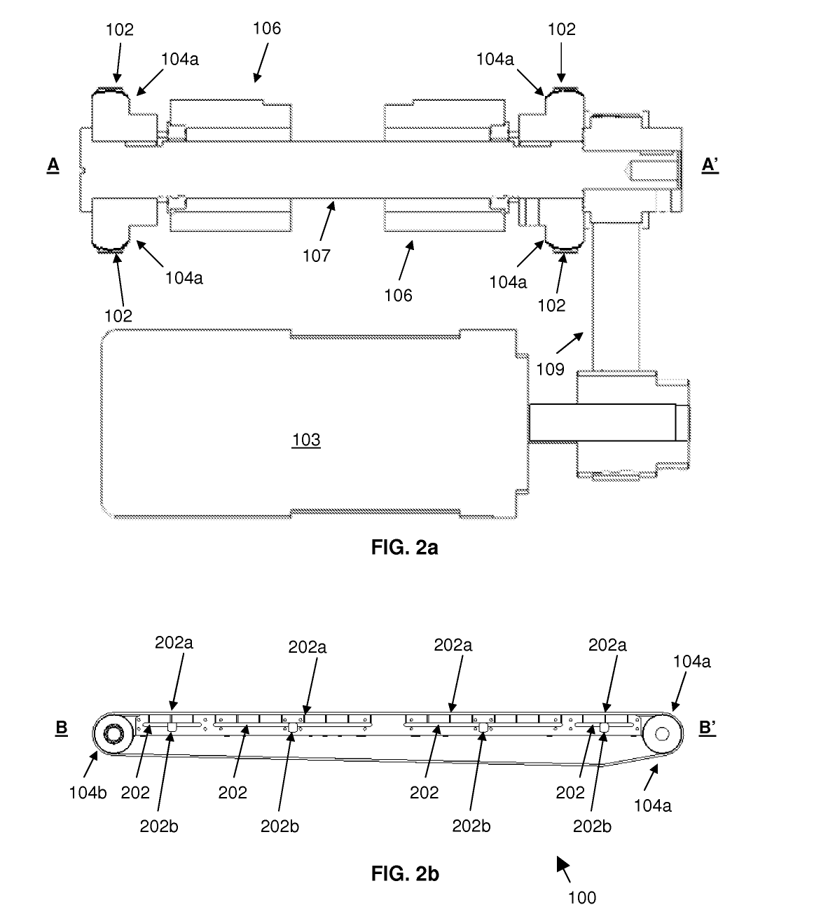

FIG. 2a is a cross-sectional view of the belt conveyor 100 along line A-A′, as shown in FIG. 1. It is seen that each of the rotatable pulleys 104a has a protruding curved surface over which a width of the corresponding endless metal strip 102 is received and tensioned. Specifically, the cross-sectional view of FIG. 2a illustrates the profile surfaces of the top and the bottom rotatable pulleys 104a defining center peaks. Such curved surfaces of the rotatable pulleys 104a have the advantage of providing a stronger grip on the endless metal strips 102 to ensure that they are not detached from the rotatable pulleys 104a. It should be appreciated that the surfaces of the rotatable pulleys 104b at the opposite side of the belt conveyor 100 are similarly curved like those of the rotatable pulleys 104a.

Furthermore, the chassis 106 comprises a plurality of open-ended interior channels. FIG. 2b shows a cross-sectional view of the belt conveyor of FIG. 1 along line B-B′ as shown in FIG. 1, showing the plurality of open-ended interior channels 202. Specifically, one end of the open-ended interior channels 202 defines openings 202a at a high-precision grinding surface of the chassis 106—over which the endless metal strips 102 are arranged—to contact the respective metal strips 102. The opposite end of the open-ended interior channels 202 define outlets 202b, which are connected via a connecting device (shown in FIG. 1 as tubings 110) to a suction device (shown in FIG. 1 as a vacuum pump 108). Accordingly, the vacuum pump 108 is operative to create vacuum—or at least a negative differential pressure relative to the ambient environment—within the open-ended interior channels 202 to thereby generate a force on the plurality of endless metal strips 102 toward the chassis 106.

By providing a device operative to generate a force on the endless metal strips 102 towards the chassis 106, the offset displacement as experienced by the endless metal strips 102 relative to their respective continuous paths during operation of the belt conveyor 100 may be further reduced. Advantageously, this further improves the stability of the endless metal strips 102, and accordingly, the on-the-fly inspection accuracy of the solar wafers as they are conveyed by the belt conveyer 100.

It should be appreciated that other devices to generate an attraction force on the endless metal strips 102 may be used in place of the vacuum pump 108. For instance, a magnet may be housed within the chassis 106 to generate a magnetic force on the endless metal strips 102 towards the chassis 106, in order to minimize the offset displacement as experienced by the endless metal strips 102 relative to their respective continuous paths during operation of the belt conveyor 100.

Preferably, the endless metal strips 102 do not comprise any through-hole so that the effect of the vacuum pump 108 (or the magnet) during operation does not affect the dimensions of the solar wafers (e.g. their flatness as measured through their bows and/or warps), which might undesirably affect the accuracy of the on-the-fly inspection of the solar wafers by the inspection device.

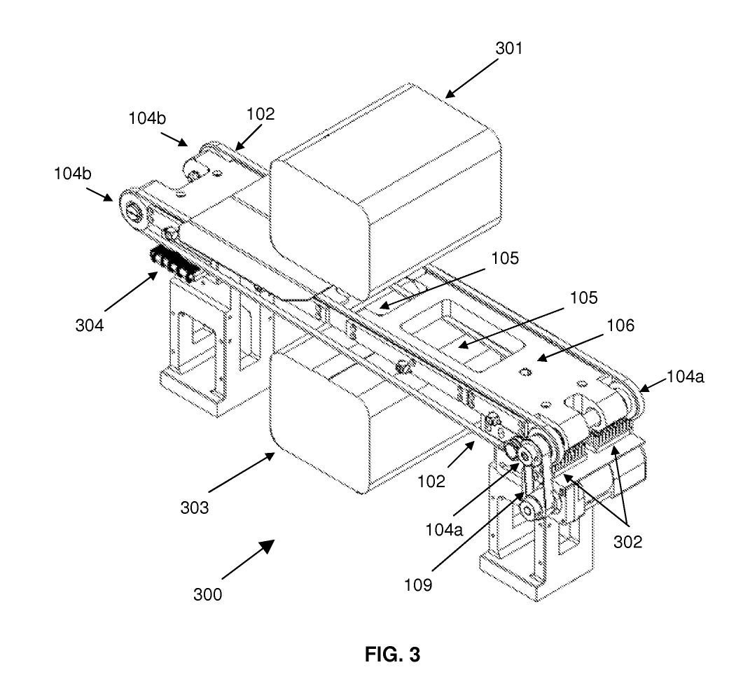

FIG. 3 shows a belt conveyor 300 according to a second embodiment of the invention. The structure of the belt conveyor 300 is largely similar to the belt conveyor 100 according to the first embodiment as described above. For instance, the belt conveyor 300 comprises an inspection device (shown in FIG. 3 as inspection devices 301, 303) for inspecting the solar wafers. The inspection device may include a 3D inspection system—comprising laser and vision systems—for measuring various dimensions (e.g. thickness) of the solar wafers. Specifically, the inspection device is arranged relative to one of the cavities 105 of the chassis 106 to measure the various dimensions of the solar wafers as the solar wafers are conveyed by the belt conveyor 100 during fabrication. For instance, and as shown in FIG. 3, the inspection device 301 is arranged above one of the cavities 105 while the inspection device 303 is arranged below the same one of the cavities 105.

However, the belt conveyor 300 further comprises a cleaning device (shown as a plurality of brushes 302 and a wiper 304) to perform real-time self-cleaning of the plurality of endless metal strips 102 when the belt conveyor 300 is in use.

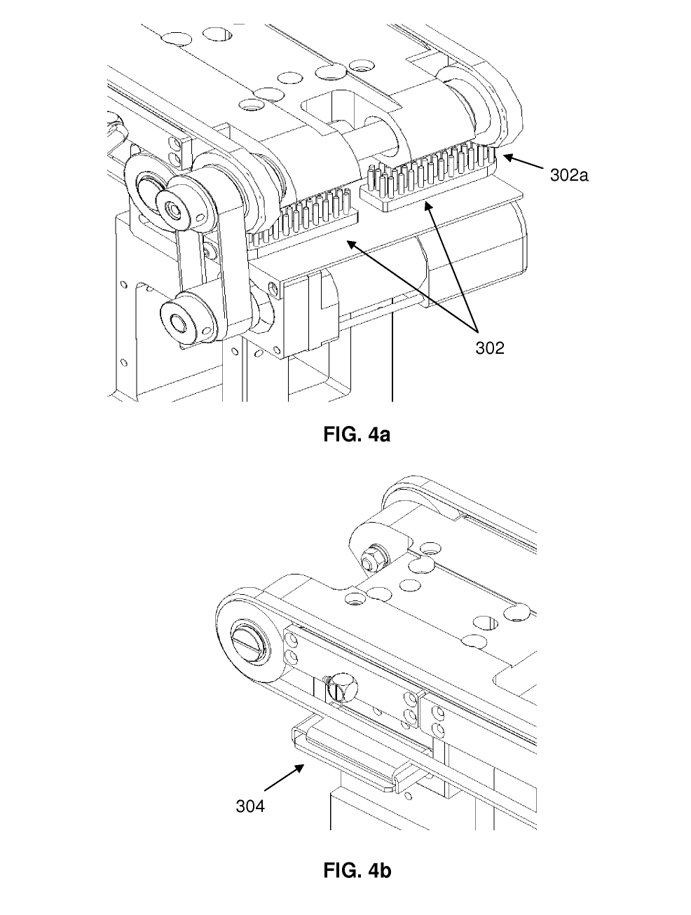

FIG. 4a is a close-up view of a section of the belt conveyor 300 which more clearly shows the plurality of brushes 302. Each of the plurality of brushes 302 comprises bristles 302a for removing any contaminants (such as silicon dust and/or other contaminant particles) that may be accumulated on the endless metal strips 102 when the belt conveyor 300 is in use.

FIG. 4b is a close-up view of another section of the belt conveyor 300 which more clearly shows the wiper 304 of the belt conveyor 300. The wiper 304 may be made of polyester material that is suitable for clean-room applications. Similarly, the wiper 304 removes any contaminants (such as silicon dust and/or other contaminant particles) that may be accumulated on the endless metal strips 102 when the belt conveyor 300 is in use.

Specifically, both the brushes 302 and the wiper 304 remove contaminants accumulated on the endless metal strips 102 so that they may be free of contaminants that will contaminate the solar wafers during fabrication. Advantageously, the quality of the fabricated solar wafers may be improved.

It should be appreciated that other embodiments of the belt conveyor are also possible without departing from the scope of the present invention. For instance, although the plurality of endless metal strips 102 are arranged along opposed edges of the chassis 106 in the described embodiments, it should be appreciated that such an arrangement is not essential since they may also arranged along other sections of the width of the chassis 106, so long as they serve the purpose of supporting the solar wafers as the solar wafers are conveyed by the belt conveyor during fabrication.

In addition, although the described embodiments of the belt conveyor include the chassis 106, it should be appreciated that the chassis 106 is merely an optional feature of the belt conveyor, since the belt conveyor can also function to convey the solar wafers during fabrication by tensioning the endless metal strips 102 over the respective pulleys 104a, 104b without the chassis 106.

Further, although the belt conveyor 300 according to the second embodiment of the invention comprises a plurality of brushes 302 for cleaning the plurality of endless metal strips 102, a single brush may equally suffice to fulfill the cleaning function.

1. A belt conveyor for conveying solar wafers during fabrication, the belt conveyor comprising:
a plurality of endless metal strips for supporting the solar wafers;
a plurality of rotatable pulleys configured to receive the plurality of endless metal strips, and which rotate to convey each of the plurality of endless metal strips along a continuous path to thereby convey the solar wafers; and
an inspection device configured to inspect the solar wafers while the solar wafers are being conveyed by the plurality of endless metal strips.

2. The belt conveyor of claim 1, wherein each of the plurality of rotatable pulleys comprises a protruding curved surface over which a width of the corresponding endless metal strip is received.

3. The belt conveyor of claim 1, further comprising a chassis, wherein the plurality of rotatable pulleys are arranged at opposite ends of the chassis.

4. The belt conveyor of claim 3, wherein the plurality of endless metal strips are arranged along opposed edges of the chassis.

5. The belt conveyor of claim 3, wherein the chassis comprises at least one cavity, so that the inspection device is operative to inspect the solar wafers through the at least one cavity while the solar wafers are being conveyed by the plurality of endless metal strips.

6. The belt conveyor of claim 3, further comprising a device operative to generate an attraction force on each of the plurality of endless metal strips towards the chassis to minimize an offset displacement of each of the plurality of endless metal strips with respect to the continuous path.

7. The belt conveyor of claim 6, wherein the device comprises a vacuum pump, and the chassis comprises a plurality of open-ended interior channels, wherein one end of the plurality of open-ended interior channels contacts the plurality of endless metal strips whereas the opposite end of the plurality of open-end interior channels is connected to the vacuum pump so that a negative pressure is created within the interior channels when the vacuum pump is operative to thereby generate the force on the plurality of endless metal strips towards the chassis.

8. The belt conveyor of claim 6, wherein the device comprises a magnet to generate a magnetic force on the plurality of endless metal strips towards the chassis.

9. The belt conveyor of claim 1, further comprising a cleaning device for cleaning the plurality of endless metal strips.

10. The belt conveyor of claim 9, wherein the cleaning device comprises a brush having bristles for cleaning the plurality of endless metal strips.

11. The belt conveyor of claim 9, wherein the cleaning device comprises a wiper for wiping the plurality of endless metal strips clean.
